(19) United States
(12) Patent Application Publication
(10) Pub. No.: US 2013/0107944 A1
(43) Pub. Date: May 2, 2013

(54) MOVING IMAGE ENCODING METHOD AND DECODING METHOD

(71) Applicants: Takashi WATANABE, Yokohama-shi (JP); Tomoo Yamakage, Yokohama-shi (JP); Takeshi Chujoh, Kawasaki-shi (JP)

(72) Inventors: Takashi WATANABE, Yokohama-shi (JP); Tomoo Yamakage, Yokohama-shi (JP); Takeshi Chujoh, Kawasaki-shi (JP)

(21) Appl. No.: 13/725,242

(22) Filed: Dec. 21, 2012

Related U.S. Application Data
(63) Continuation of application No. PCT/JP2010/060871, filed on Jun. 25, 2010.

(51) Int. Cl. H04N 7/26

(52) U.S. Cl. CPC H04N 19/0009
USPC 375/240.03

(57) ABSTRACT

In one embodiment, a moving image decoding apparatus includes a decoder and a processor. The decoder decodes an encoded data to obtain a filter information, an application information with a value appended to a head of the application information, a block division information indicating how to divide an image to be decoded into blocks, and a quantized transform coefficient, the value indicates the number of blocks to which filter is applied. The processor generates a reconstructed image by applying the filter to the block in a decoded image if the application information indicates the block to be applied the filter, the decoded image is obtained by adding a prediction error to a prediction image.

### CROSS REFERENCE TO RELATED APPLICATIONS

This application is a Continuation Application of PCT Application No. PCT/JP2010/060871, filed Jun. 25, 2010, the entire contents of which are incorporated herein by reference.

### FIELD

Embodiments described herein relate generally to a moving image encoding method and decoding method.

### BACKGROUND

“Quad-tree based Adaptive Loop Filter” (to be abbreviated as QALF hereinafter) is known as a technique for setting information indicating filter coefficients and regions to which a filter is applied on the encoding side, transmitting that information to the decoding side, and applying loop filter processing to the filter application regions using the received filter information on the decoding side to eliminate encoding distortions of a decoded image. The QALF divides an image into blocks having variable sizes using a tree structure of quadtrees, and can selectively decide whether or not to apply the filter for each block.

On the other hand, in H.264, using a block having a fixed size called a macroblock as an encoding block as a processing unit of encoding, a prediction method, prediction block size, transform block size, and the like are set in that block. A method of controlling the encoding blocks using quadtrees is available. With this method, since encoding blocks are recursively expressed in the tree structure, encoding block sizes are variable within a frame. Switching of filter application is made for each encoding block, and filter application information is multiplexed in encoded data of an encoding block.

### BRIEF DESCRIPTION OF THE DRAWINGS

FIG. 1 is a block diagram illustrating a moving image encoding apparatus.

FIG. 2 is a block diagram illustrating a loop filter information generator.

FIG. 3 is a block diagram illustrating an entropy encoder.

FIG. 4 is a view illustrating a division example of encoding blocks.

FIG. 5 is a view illustrating a control example of filter application to encoding blocks.

FIG. 6 is a view illustrating an example of a syntax structure according to an embodiment.

FIG. 7 is a flowchart illustrating an operation example of the entropy encoder.

FIG. 8 is a view illustrating a first description example of the syntax structure of a loop filter data syntax.

FIG. 9A is a view illustrating a second description example of the syntax structure of the loop filter data syntax.

FIG. 9B is a view illustrating a third description example of the syntax structure of the loop filter data syntax.

FIG. 10 is a view illustrating a fourth description example of the syntax structure of the loop filter data syntax.

FIG. 11 is a block diagram illustrating another example of the entropy encoder.

FIG. 12 is a block diagram illustrating a moving image decoding apparatus.

FIG. 13 is a block diagram illustrating an entropy decoder.

FIG. 14 is a block diagram illustrating another example of the entropy decoder.

FIG. 15 is a block diagram illustrating a moving image encoding apparatus with deblocking filter process.

FIG. 16 is a block diagram illustrating a moving image decoding apparatus with deblocking filter process.

FIG. 17 is a block diagram illustrating another example of the moving image decoding apparatus.

FIG. 18 is a block diagram illustrating a moving image encoding apparatus used as a post filter.

FIG. 19 is a block diagram illustrating a moving image decoding apparatus used as a post filter.

### DETAILED DESCRIPTION

In the conventional moving image encoding methods such as MPEG-2, MPEG-4, and H.264, encoded data is generated simultaneously with encoding processing. On the other hand, appropriate filter application information cannot be calculated unless encoding for a target region (picture, slice, or the like) is completed. For this reason, in order to multiplex the filter application information in encoded data of an encoding block, the encoded data of the encoding block has to be rewritten as needed after a position of the filter application information in the encoded data of the encoding block is stored once, and appropriate filter application information is calculated.

In one embodiment, a moving image decoding apparatus includes a decoder and a processor. The decoder is configured to decode an encoded data to obtain a filter information, an application information with a value appended to a head of the application information, a division information, and a quantized transform coefficient, the filter information indicates filter coefficient of a filter, the division information indicates how to divide an image to be decoded into blocks, the application information indicates whether or not to apply the filter to a block, the value indicates the number of blocks to which filter is applied. The processor is configured to generate a reconstructed image by applying the filter to the block in a decoded image if the application information indicates the block to be applied the filter, the decoded image is obtained by adding a prediction error to a prediction image, the prediction error is generated by inverse-quantizing and inverse-transforming the quantized transform coefficient.

A moving image encoding method and decoding method according to this embodiment will be described in detail hereinafter with reference to the drawings. Assume that in the following embodiments, components denoted by the same reference numerals perform the same operations, and a repetitive description thereof will be avoided.

(Encoding Apparatus)

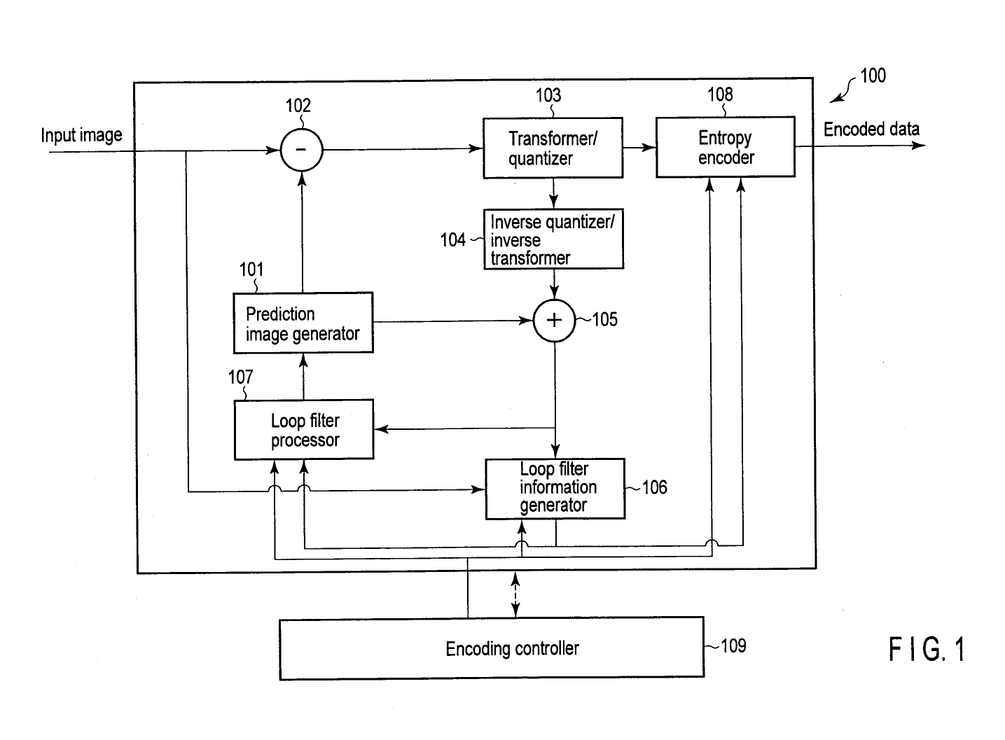

A moving image encoding apparatus, which executes a moving image encoding method according to this embodiment, will be described in detail below with reference to FIG. 1.

A moving image encoding apparatus 100 according to this embodiment includes a prediction image generator 101, a subtractor 102, a transformer/quantizer 103, an inverse quantizer/inverse transformer 104, an adder 105, a loop filter information generator 106, a loop filter processor 107, and an entropy encoder 108. The overall operation of the moving image encoding apparatus 100 is controlled by an encoding controller 109.

The prediction image generator 101 executes predetermined prediction processing for an externally input image including a plurality of pixels (to be referred to as an input image hereinafter), thus generates a prediction image. The prediction processing can use general processing such as prediction of a time direction based on motion compensation and prediction of a spatial direction using encoded pixels in a frame, and a detailed description thereof will not be given.

The subtractor 102 receives the input image and the prediction image from the prediction image generator 101, and calculates a difference between the input image and prediction image, thereby generating a prediction error image.

The transformer/quantizer 103 receives the prediction error image, and applies transform processing to the prediction error image to generate transform coefficients. After that, the transformer/quantizer 103 applies quantization processing to the transform coefficients to generate quantized transform coefficients. The transform processing executes, for example, orthogonal transform using DCT (Discrete Cosine Transform). Note that the transform coefficients may be generated using a method such as wavelet transform or independent component analysis. The quantization processing quantizes the transform coefficients based on quantization parameters set by the encoding controller 109 (to be described later).

The inverse quantizer/inverse transformer 104 receives the quantized transform coefficients from the transformer/quantizer 103, inverse quantizes the quantized transform coefficients based on quantization parameters, and then applies inverse transform processing (for example, inverse DCT) to the obtained transform coefficients, thus generating a prediction error image. Note that the inverse quantizer/inverse transformer 104 can execute inverse processes for those of the transformer/quantizer 103. For example, when the transformer/quantizer 103 executes wavelet transform and quantization, the inverse quantizer/inverse transformer 104 can execute inverse quantization and inverse wavelet transform.

The adder 105 receives the prediction image from the prediction image generator 101 and the prediction error image from the inverse quantizer/inverse transformer 104, and adds the prediction image and prediction error image, thus generating a local decoded image.

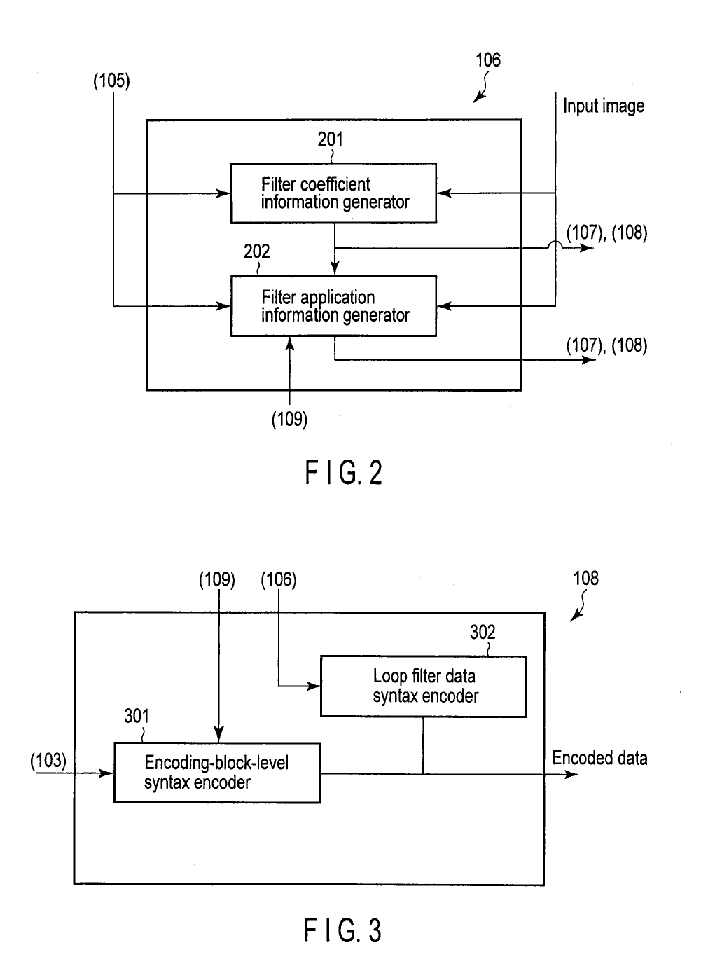

The loop filter information generator 106 receives the input image, the local decoded image from the adder 105, and encoding block division information from the encoding controller 109, respectively. The encoding block division information is information indicating how to divide encoding blocks used as a unit of an encoding processing. The loop filter information generator 106 then generates filter coefficient information and filter application information. The filter coefficient information is information of filter coefficients of a filter to be applied to a pixel region (to be also simply referred to as a region hereinafter). The filter application information is information indicating whether or not to apply the filter for each encoding block. Details of the loop filter information generator 106 will be described later using FIG. 2.

The loop filter processor 107 receives the local decoded image from the adder 105, the filter application information and filter coefficient information from the loop filter information generator 106, and the encoding block division information from the encoding controller 109, respectively. The loop filter processor 107 then applies the filter indicated by the filter coefficient information to a region indicated by the filter application information in association with the local decoded image, thereby generating a reconstructed image as an image after filter application. The generated reconstructed image is referred to when the prediction image generator 101 generates a prediction image.

The entropy encoder 108 receives the quantized transform coefficients from the transformer/quantizer 103, the filter coefficient information and filter application information from the loop filter information generator 106, and encoding parameters from the encoding controller 109, respectively. The entropy encoder 108 entropy-encodes (for example, by Huffman encoding or arithmetic encoding) the quantized transform coefficients, filter coefficient information, filter application information, and encoding parameters, and externally outputs encoded data. The encoding parameters include information such as prediction mode information, motion information, encoding block division information, and quantization parameters. Details of the entropy encoder 108 will be described later using FIG. 3.

The encoding controller 109 executes encoding block division control, feedback control of a generated code size, quantization control and mode control, and so forth, and controls the overall encoder.

The loop filter information generator 106 will be described below with reference to FIG. 2.

The loop filter information generator 106 includes a filter coefficient information generator 201 and a filter application information generator 202.

The filter coefficient information generator 201 receives the input image and the local decoded image from the adder 105, respectively, and sets filter coefficients of a loop filter to be applied to the local decoded image, thus generating the filter coefficient information.

The filter application information generator 202 receives the input image, the local decoded image from the adder 105, the filter coefficient information from the filter coefficient information generator 201, and the encoding block division information from the encoding controller 109. Then, the filter application information generator 202 refers to local decoded blocks to determine whether or not a filter is applied to one or more encoding blocks, thereby generating the filter application information. The determination method associated with filter application of the filter application information generator 202 will be described later.

The entropy encoder 108 will be described below with reference to FIG. 3.

The entropy encoder 108 includes an encoding block level syntax encoder 301 and a loop filter data syntax encoder 302.

The encoding block level syntax encoder 301 receives the quantized transform coefficients from the transformer/quantizer 103, and the encoding block division information from the encoding controller 109, respectively, and entropy-encodes information including the quantized transform coefficients and encoding block division information.

The loop filter data syntax encoder 302 receives the filter coefficient information and the filter application information from the loop filter information generator 106, and entropy-encodes the filter coefficient information and filter application information. The detailed operation of the entropy encoder 108 will be described later.

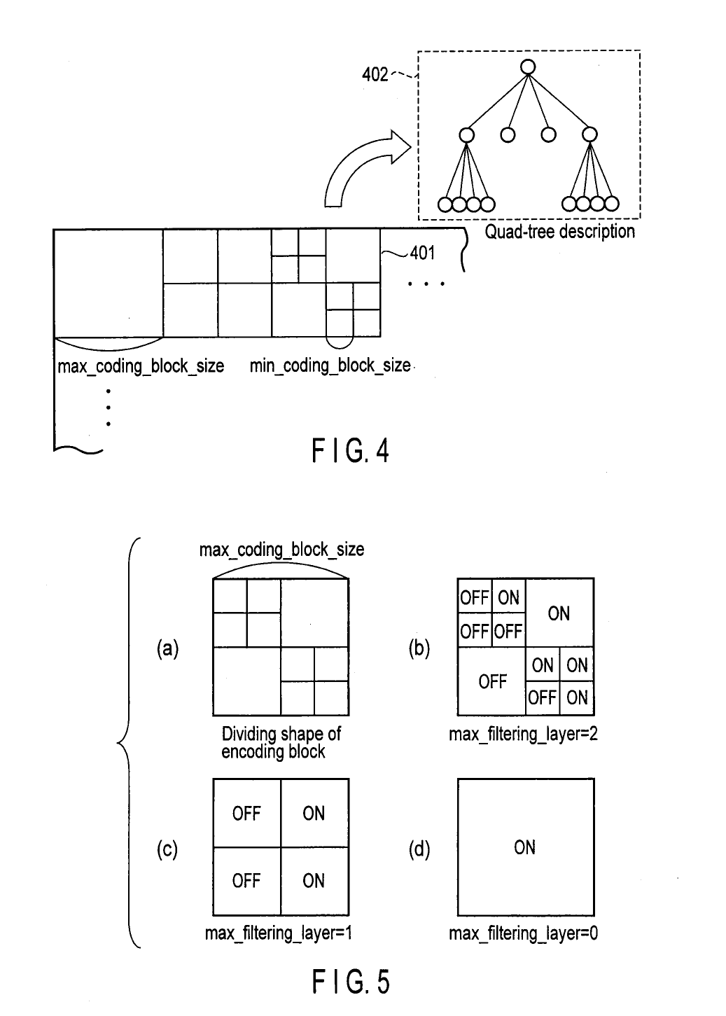

Encoding blocks having variable sizes assumed in this embodiment will be described in detail below with reference to FIG. 4.

Encoding processing is executed for respective encoding blocks obtained by dividing an image into a plurality of blocks. In the conventional moving image encoding standard specification such as H.264, blocks of a fixed size called macroblocks are used. However, this embodiment targets at a moving image encoding method using encoding blocks having variable sizes in a frame. This embodiment will exemplify a case in which block division is controlled using a tree structure of a quadtree, but any other block division methods are applicable. Encoding blocks of variable sizes can be adjusted by controlling block division using the tree structure of the quadtree. More specifically, the sizes of encoding blocks can be adjusted by controlling parameters “max_coding_block_size” and “max_coding_layer” in a syntax by the encoding controller 109.

“max_coding_block_size” indicates a maximum size of an encoding block, and “max_coding_layer” indicates a maximum depth of the tree structure of the quadtrees. From these parameters, a minimum size “min coding block size” of an encoding block is decided. For example, in the example of an encoding block 401 in FIG. 4, when “max_coding_block_size”=64 and “max_coding_layer”=2, since a tree structure of a depth=2 is taken from the maximum size, “min coding block size”=16. An illustration 402 illustrates the tree structure of the quadtree of the encoding blocks 401. Each encoding block can be further divided into four encoding blocks. To an encoding block having a size larger than “min coding block size”, information as to whether or not to further divide a block is appended. Fixed values may be used for “max_coding_block_size” and “max_coding_layer”, or these parameters may be variable in a unit of a slice or the like. In these cases, “max_coding_block_size” and “max_coding_layer” have to be encoded in each unit. Furthermore, unique parameters may be used on the encoding side and decoding side, and parameters need not be encoded in this case.

The size of each encoding block can be freely set. However, in this embodiment, the size of each encoding block is set based on an encoding cost expressed by:

cost=D+λ×R (1)

where D is a sum of squared residual, and R is a code size.

The encoding controller 109 calculates encoding costs using equation (1) respectively for a case in which encoding is executed using each encoding block, and a case in which encoding is executed by further dividing the encoding block into four encoding blocks, and selects a size of the encoding block corresponding to the smaller encoding cost. In this manner, since the encoding block size is variable in a frame, encoding can be executed in consideration of characteristics for respective regions in an image.

Encoding processing of the moving image encoding apparatus according to this embodiment will be described below.

The moving image encoding apparatus 100 according to this embodiment receives an input image, and the subtractor 102 generates a prediction error image by executing subtraction processing between the input image and a prediction image from the prediction image generator 101. Subsequently, the generated prediction error image is transformed and quantized in the transformer/quantizer 103, thus generating quantized transform coefficients as a result. The quantized transform coefficients are encoded by the entropy encoder 108. On the other hand, the quantized transform coefficients are inverse quantized and inverse transformed in the inverse quantizer/inverse transformer 104, thus outputting a prediction error image. The prediction error image is added to the prediction image from the prediction image generator 101 by the adder 105, thus generating a local decoded image.

The aforementioned series of processes correspond to general encoding processing in moving image encoding so-called hybrid encoding in which prediction processing and transform processing are executed. Note that this embodiment has explained the encoding processing which executes prediction, transform, and quantization. However, some processes may be skipped like DPCM (Differential Pulse Code Modulation) which executes only prediction from neighboring pixels.

The operation of the loop filter information generator 106 will be described below.

The filter coefficient generator 201 sets, based on the local decoded image and input image, filter coefficients so as to minimize mean square errors between an image obtained by applying filter processing to the local decoded image and the input image.

The filter application information generator 202 determines for each encoding block based on the filter coefficient information and encoding block division Information whether or not mean square errors between an image to which a filter is applied and the input image are reduced, thereby generating filter application information for each block. That is, the filter application information is set to apply a filter for each block when an error between the block of filtered image and original image is reduced by applying the filter.

Subsequently, the filter application information generator 202 executes the aforementioned determination process for a plurality of parameters “max_filtering_layer”, and selects a parameter “max_filtering_layer” corresponding to a smallest encoding cost. The parameter “max_filtering_layer” indicates how many layer of the quadtree in division of encoding blocks is to be used to set the filter application information. Also, a region, which is indicated by a dividing shape of this encoding block and the parameter “max_filtering_layer”, and is used as a unit to determine whether or not to apply the filter, is also called a filter application determination region.

Note that filter application information may be set for a processing unit including a plurality of encoding blocks in addition to that for each encoding block. For example, filter application information may be set for each encoding slice. In this case, by calculating and comparing a cost when no filter is applied to an encoding slice and that when a filter is applied to each block, the filter application information for the encoding slice can be set.

The filter application determination regions of encoding blocks will be described below with reference to FIG. 5.

FIG. 5(a) shows the dividing shapes of the encoding blocks 401 shown in FIG. 4. “ON” and “OFF” in FIGS. 5(b) and 5(c) indicate whether or not to apply the filter. In case of “ON”, the filter is applied.

In case of “OFF”, the filter is not applied. As shown in FIG. 5(b), when “max_coding_layer”=2 and “max_filtering_layer”=2, since the encoding block of the tree structure actually used in encoding is same as filter application determination regions at a depth=2 (second layer), whether or not to apply the filter for each encoding block can be decided.

On the other hand, as shown in FIG. 5(c), when “max_filtering_layer”=1, since a filter application determination region corresponds to a depth=1 (first layer), whether or not to apply the filter is decided respectively for encoding blocks obtained by dividing the maximum size (“max_coding_block_size”) of an encoding block into four blocks once. Also, as shown in FIG. 5(d), when “max_filtering_layer”=0, since an encoding block is not divided, whether or not to apply the filter is decided for an encoding block of the maximum size.

In this embodiment, a two-dimensional Wiener filter generally used in image reconstruction is used as the filter. When it is set not to apply the filter for each encoding slice unit, the filter is not applied to all pixels in a slice, and filter application information for each block is discarded. On the other hand, when it is set to apply the filter for each encoding slice unit, the filter is applied according to the filter application information for each block.

Note that the case of one filter has been explained in this embodiment. A plurality of filters may be prepared, and filter types may be switched according to the filter application information in addition to whether or not to apply the filter.

Furthermore, whether or not to apply the filter may be switched according to the filter application information, and filter types may be switched for each pixel or block of a decoded image based on an activity or pixel value.

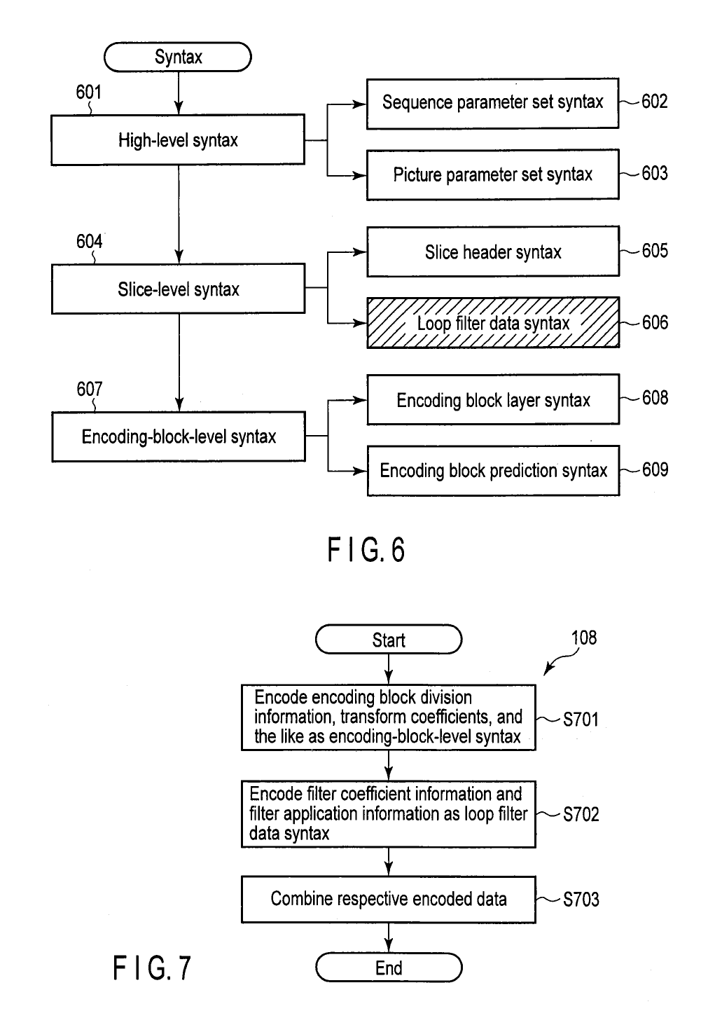

Syntax elements according to this embodiment will be described in detail below with reference to FIG. 6.

The following description will be given under the assumption that the filter coefficient information and filter application information are transmitted for each slice unit. As shown in FIG. 6, a syntax mainly includes three syntaxes, that is, a high level syntax, a slice level syntax, and an encoding block level syntax. In a high level syntax 601, syntax information of upper layers equal to or higher than a slice is described. In a slice level syntax 604, required information is described for each slice. In an encoding block level syntax 607, encoding block division information or a transform coefficient, prediction mode information, motion vector, and the like required for each encoding block are described.

Furthermore, the high level syntax 601 includes sequence and picture level syntaxes such as a sequence parameter set syntax 602 and picture parameter set syntax 603. The slice level syntax 604 includes a slice header syntax 605, and a loop filter data syntax 606 including the filter coefficient information and filter application information. The encoding block level syntax 607 includes an encoding block layer syntax 608 including the encoding block division information, and an encoding block prediction syntax 609.

For example, when the parameters “max_coding_block_size” and “max_coding_layer” required to control the aforementioned divisions of encoding blocks are fixed for respective sequences, these parameters may be appended to the sequence parameter set syntax 602; when these parameters are variables for each sequence, they may be appended to the slice header syntax 605.

The operation of the entropy encoder will be described below with reference to the flowchart shown in FIG. 7.

In step S701, the encoding block level syntax encoder 301 encodes mode information and motion information as a series of encoded data of the encoding block level syntax in addition to the encoding block division information and quantized transform coefficient information.

In step S702, the loop filter data syntax encoder 302 encodes the filter coefficient information and filter application information as a series of encoded data of the loop filter data syntax independently of the encoding block level syntax.

In step S703, the respective encoded data of the loop filter data syntax and encoding block level syntax are combined to generate one encoded data to be sent to the decoding side.

Since the filter coefficient information and filter application information are set after encoding for one slice is complete and a decoded image is generated, the filter application information is not decided at the encoding timing of the encoding block level syntax. Hence, if the filter application information is appended into the encoding block level syntax, pixel positions of regions to which the filter is applied have to be stored for respective encoding blocks, and whether or not to apply the filter to these regions of the encoding blocks has to be rewritten again after the filter application information is set, resulting in complicated encoding processing and an increase in processing amount.

In this embodiment, pieces of filter application information for one slice are encoded together in the loop filter data syntax in place of the encoding block level syntax so as to reveal the number of encoding blocks to which the filter is applied.

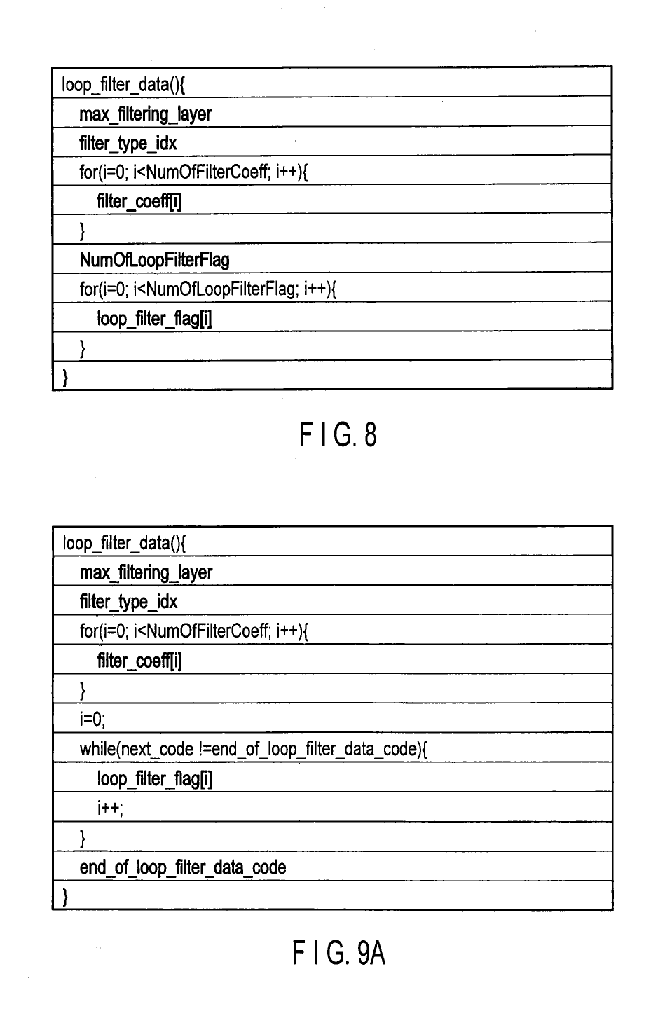

Description examples of the loop filter data syntax will be described in detail below with reference to FIGS. 8, 9A, 9B, and 10.

The loop filter data syntax 606 shown in FIG. 8 describes filter coefficient information and filter application information as parameters associated with the loop filter of this embodiment. “filter_type_idx” is an index indicating a shape or tap length of the loop filter. “filter_type_idx” corresponds to “NumOfFilterCoeff” as the number of filter coefficients, and “filter coeff” is a filter coefficient. “loop_filter_flag” is a 1-bit flag indicating whether or not to apply the loop filter to each encoding block. For example, this flag can be set to be “1” when the filter is applied; it can be set to be “0” when the filter is not applied. “NumOfLoopFilterFlag” is the total number of filter application determination regions.

In this example, “NumOfLoopFilterFlag” is appended before “loopfilterflag”. This allows the decoding side to detect the presence of pieces of filter application information as many as the number of blocks indicated by “NumOfLoopFilterFlag”. For example, when FIG. 5(b) configures one slice, since “NumOfLoopFilterFlag”=10, and “loop_filter_flag” is expressed by “0100101101”, the decoding side can correctly decode “loop_filter_flag” using only information included in the loop filter data syntax. Furthermore, the decoding side can execute filter processing by determining whether or not to apply the filter for each corresponding encoding block based on the encoding block division information and “max filter layer”.

In this manner, without executing any complicated processing for storing and rewriting all pixel positions in regions of encoding blocks to which the filter is applied on the encoding side, the number of encoding blocks need only be inserted in the loop filter data syntax, thus reducing an encoding processing amount.

“NumOfLoopFilterFlag” may be encoded by either variable-length encoding or fixed-length encoding. As an encoding method, a method of changing encoding methods based on an image size or parameters associated with divisions of encoding blocks is available.

Since one slice never assumes a region larger than one frame, the minimum number of blocks and the maximum number of blocks which can be included in one slice, that is, a value range that the number of blocks can assume can be obtained from at least one of an image size, “max_coding_block_size”, “min coding block size”, and “max_filtering_layer”. Therefore, when “NumOfLoopFilterFlag” is encoded by variable-length encoding, code tables are changed using a probability model according to the value range that the number of blocks can assume. When “NumOfLoopFilterFlag” is encoded by fixed-length encoding, it is encoded by a minimum bit length which can express the value range that the number of blocks can assume. In this way, even when the image size or block size has varied, an appropriate encoding method can be selected. Furthermore, since the aforementioned parameters can also be used on the decoding side, decoding can be correctly done by selecting an identical bit length on the encoding side and decoding side.

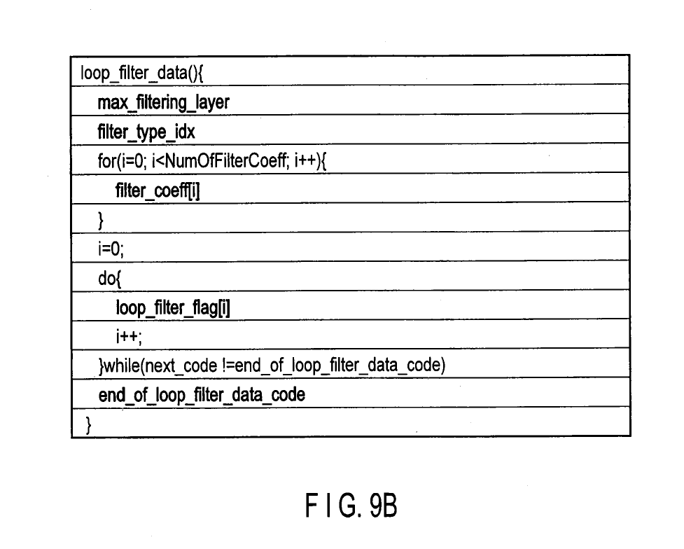

As other description examples of the loop filter data syntax 606, as shown in FIGS. 9A and 9B, a unique bit sequence may be encoded at the end of “loop_filter_data” to determine the end of “loop_filter_data”. FIG. 9A shows a description example when “loop_filter_flag” need not be set, and FIG. 9B shows a description example under the assumption that at least one or more pieces of information “loop_filter_flag” are always set.

By appending the unique bit sequence indicating the end position of “loop_filter_data” to the end of “loop_filter_data”, since the decoding side can determine that filter application information is set for bits before the unique bit sequence appears. Hence, even when “NumOfLoopFilterFlag” cannot be detected, the appropriate number of pieces of information “loop_filter_flag” can be decoded.

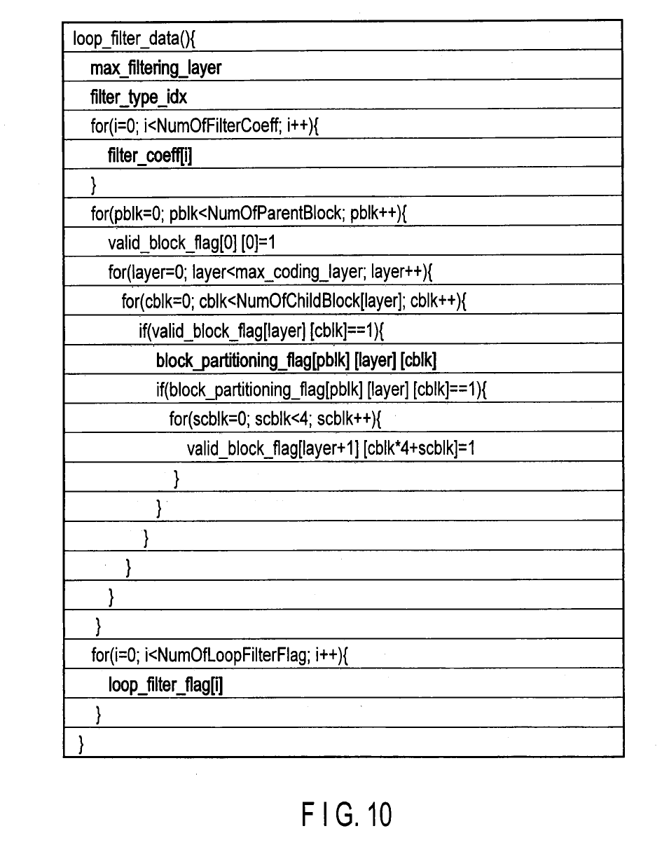

As yet another method, the encoding block division information may be described in “loop_filter_data” using the tree structure of the quadtree. FIG. 10 shows a description example of the loop filter data syntax 606 in this case.

In FIG. 10, “NumOfParentBlock” expresses the number of blocks of “max_coding_block_size” included in one slice, and quadtrees are included as many as “NumOfParentBlock”. “NumOfChildBlock” expresses the number of encoding blocks divided from one “max_coding_block_size” when divisions has been made to a certain layer. “block_partitioning_flag” expresses whether or not an encoding block is further divided into four to have each block of “max_coding_block_size” as a start point of a quadtree. When “block partitioning flag”=1, an encoding block is further divided, and “valid block flag” of a block located in a layer immediately below the current layer is set to be “1”. When an encoding block is not divided any more, “block_partitioning_flag”=0 (zero), and “valid block flag” of a block located in a layer immediately below the current layer is set to be “0 (zero)”. With this description, the tree structure of the quadtrees shown in FIG. 4 can be expressed. However, when one slice is a region smaller than one frame, “NumOfParentBlock” cannot be specified by only “max_coding_block_size”, information indicating a shape or size of the slice is required.

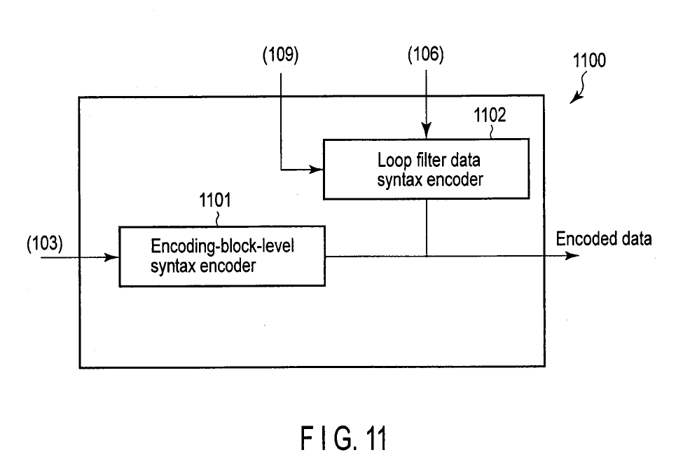

An entropy encoder when the loop filter data syntax shown in FIG. 10 will be described in detail below with reference to the block diagram shown in FIG. 11.

An entropy encoder 1100 shown in FIG. 11 includes an encoding block level syntax encoder 1101 and loop filter data syntax encoder 1102.

The encoding block level syntax encoder 1101 performs nearly the same operation as that of the encoding block level syntax encoder 301 shown in FIG. 3, except that it does not encode the encoding block division information, and encodes the quantized transform coefficients.

The loop filter data syntax encoder 1102 performs nearly the same operation as that of the loop filter data syntax encoder 302 shown in FIG. 3, except that it also encodes the encoding block division information as a series of encoded data in addition to the filter coefficient information and filter application information. In this case, since the encoding block division information need not be appended into the encoding block level syntax, an overhead never changes seriously.

Note that in the above description of this embodiment, the slice header syntax and loop filter data syntax are different. However, a part or all of the loop filter data syntax may be included in the slice header syntax.

Furthermore, as described above, application of the loop filter can be switched for each slice unit, and the filter application information for each slice unit is stored in the slice header syntax 605. At this time, when it is determined that the loop filter is applied to a slice, the loop filter data syntax 606 is stored in the slice level syntax 604.

Alternatively, the loop filter may be controlled for a unit independent of a slice. This unit is called a loop filter slice. When one slice includes a plurality of loop filter slices, loop filter syntaxes 606 as many as the number of loop filter slices are generated. Furthermore, when a loop filter slice cannot be processed for each slice unit (for example, when a loop filter slice exists across a plurality of slices), the loop filter data syntax 606 may be included in the high level syntax 601 such as the picture parameter set syntax 603.

When there are a plurality of components which configure an image, a syntax may be generated for each component, or a common syntax may be generated for two or more components.

(Decoding Apparatus)

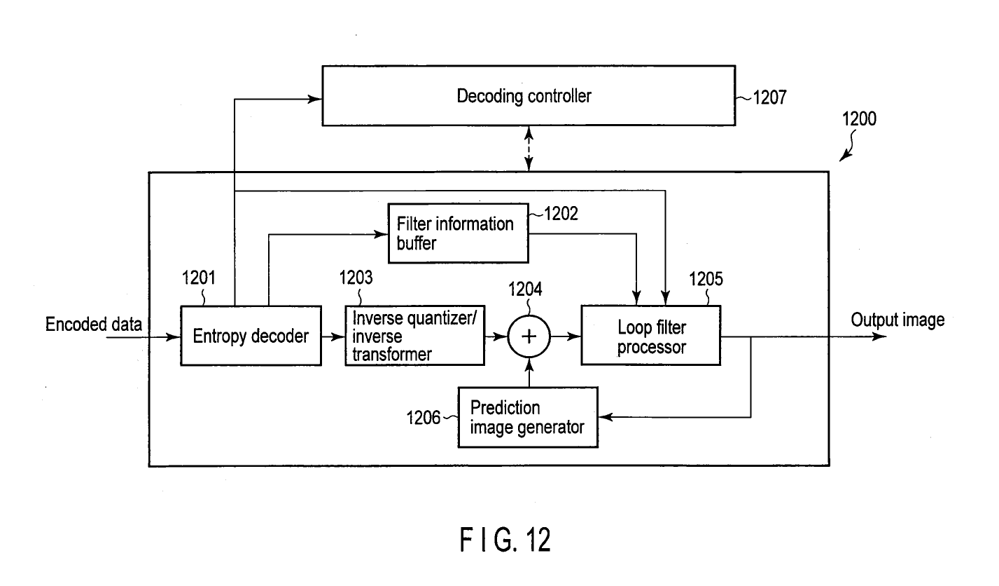

A moving image decoding apparatus corresponding to the moving image encoding apparatus will be described in detail below with reference to FIG. 12.

A moving image decoding apparatus 1200 according to this embodiment includes an entropy decoder 1201, a filter information buffer 1202, an inverse quantizer/inverse transformer 1203, an adder 1204, a loop filter processor 1205, and a prediction image generator 1206. The overall operation of the moving image decoding apparatus 1200 is controlled by a decoding controller 1207. Since the operations of the inverse quantizer/inverse transformer 1203, the adder 1204, and the prediction image generator 1206 perform the same operations as those of the corresponding units included in the moving image encoding apparatus 100 according to this embodiment, a description thereof will not be repeated.

The entropy decoder 1201 sequentially decodes code sequences of respective syntaxes of encoded data in each of the high level syntax, slice level syntax, and encoding block level syntax according to the syntax structure shown in FIG. 6 to decode quantized transform coefficients, filter coefficient information, filter application information, encoding block division information, and the like.

The filter information buffer 1202 receives the decoded filter coefficient information and the filter application information from the entropy decoder 1201 and stores these pieces of information.

The loop filter processor 1205 performs nearly the same operation as that of the loop filter processor 107 according to this embodiment, and receives the encoding block division information from the entropy decoder 1201, a decoded image from the adder 1204, and the filter coefficient information and filter application information from the filter information buffer 1202, respectively. After that, the loop filter processor 1207 applies a filter indicated by the filter coefficient information to a specific region of the decoded image based on the filter application information, thus generating an image after filter application as a reconstructed image. The reconstructed image is externally output as an output image. The reconstructed image is also referred to when the prediction image generator 1206 generates a prediction image.

The decoding controller 1207 executes the overall decoding control such as encoding block division control or decoding timing control.

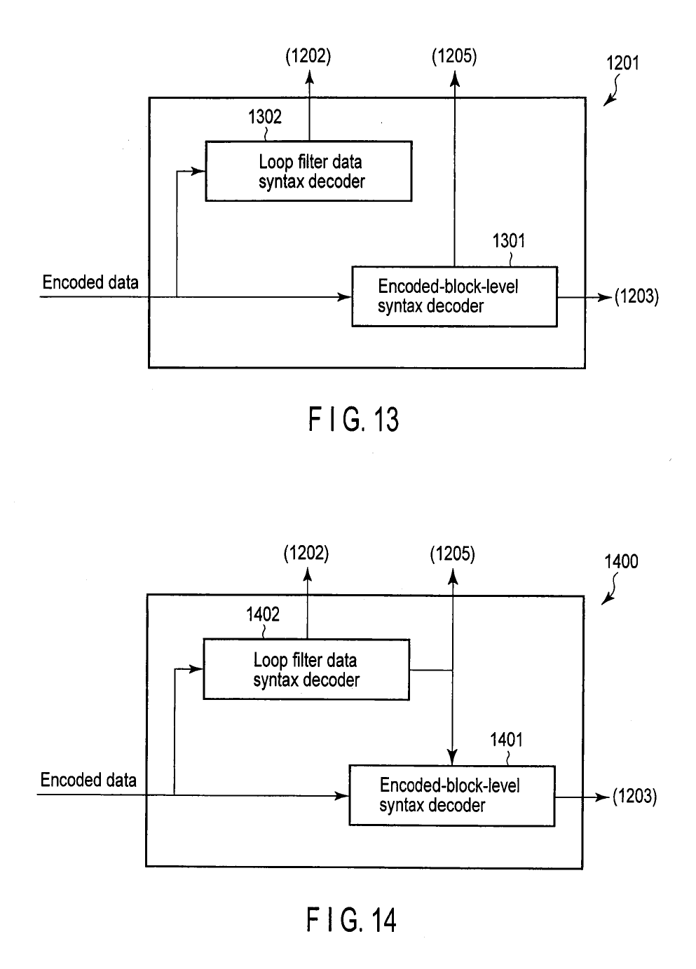

The entropy decoder 1201 will be described below with reference to FIG. 13.

The entropy decoder 1201 includes an encoding block level syntax decoder 1301 and a loop filter data syntax decoder 1302.

The encoding block level syntax decoder 1301 receives code sequences corresponding to the encoding block level syntax from the encoded data, and executes decoding processing to decode the quantized transform coefficients and encoding block division information.

The loop filter data syntax decoder 1302 receives code sequences corresponding to the loop filter data syntax from the encoded data, and executes decoding processing to decode the filter coefficient information and filter application information.

The operation of the moving image decoding apparatus 1200 will be described below. Note that a case will be described wherein the loop filter data syntax follows the syntax structures shown in FIGS. 8, 9A, and 9B.

When the encoded data is input to the moving image decoding apparatus 1200, the entropy decoder 1201 inputs code sequences corresponding to the loop filter data syntax of the encoded data to the loop filter data syntax decoder 1302, and the loop filter data syntax decoder 1302 executes decoding processing according to the syntax structure shown in FIG. 6. The obtained filter coefficient information and the filter application information are stored in the filter information buffer 1202.

Then, code sequences corresponding to the encoding block level syntax of the encoded data are input to the encoding block level syntax decoder 1301, and the encoding block level syntax decoder 1301 decodes decoding prediction mode information, motion information, encoding block division information, quantization parameters, and the like according to the syntax structure shown in FIG. 6 in addition to the transform coefficients and encoding block division information. The obtained encoding block division information is used when the decoding controller 1207 executes encoding block division control in the decoding processing. After that, the inverse quantizer/inverse transformer 1203 receives the transform coefficients decoded by the entropy decoder 1201, inverse quantizes the transform coefficients according to quantization parameters set by the decoding controller 1207, and applies inverse transform (for example, discrete cosine transform) to the obtained transform coefficients to generate a prediction error image. Next, the adder 1204 receives the prediction error image from the inverse quantizer/inverse transformer 1203, and a prediction image from the prediction image generator 1206, respectively, and generates a decoded image.

Since the aforementioned series of processes associated with decoding of the encoding block level syntax correspond to general decoding processing in moving image encoding so-called hybrid encoding in which prediction processing and transform processing are executed, a detailed description thereof will not be given.

Subsequently, the loop filter processor 1205 receives the decoded image from the adder 1204, the filter coefficient information and the filter application information from the filter information buffer 1202, and the encoding block division information from the entropy decoder 1201, and applies filter processing to the decoded image. At this time, the loop filter processor 1205 can determine filter application regions by associating the encoding block division information with the filter application information. More specifically, by obtaining filter application regions from “max_filtering_layer” and dividing shapes of encoding blocks in the syntax structure shown in each of FIGS. 8, 9A, and 9B, and associating “loop_filter_flag” to each filter application region, the decoding side can apply a filter to a block set on the encoding side. Pixel values after filter application are set as those of the reconstructed image. On the other hand, as for regions to which no loop filter is applied, pixel values at identical positions in the decoded image are set as those of the reconstructed image. The reconstructed image is output as an output image, and is referred to by the prediction image generator as needed.

Note that in the above description, the loop filter data syntax follows the syntax structure shown in each of FIGS. 8, 9A, and 9B, but it may follow the syntax structure shown in FIG. 10.

An example of an entropy decoder according to the syntax structure shown in FIG. 10 will be described below with reference to FIG. 14.

An entropy decoder 1400 shown in FIG. 14 has the same arrangement as that of the entropy decoder 1201 shown in FIG. 13, except that when code sequences corresponding to the loop filter data syntax are input to a loop filter data syntax decoder 1401 and undergo decoding processing, the encoding block division information is decoded in addition to the filter coefficient information and filter application information. Therefore, the encoding block division information decoded by the loop filter data syntax decoder 1402 can be used when an encoding block level syntax decoder 1401 decodes code sequences corresponding to the encoding block level syntax, in addition to the aforementioned use.

According to this embodiment described above, since pieces of filter application information are encoded together and combined as a series of encoded data without being multiplexed in encoded data of encoding blocks, processing for storing and rewriting positions of filter application information in encoded data of encoding blocks need not be executed. Hence, the pieces of filter application information need only be encoded together in the loop filter data syntax, thus simplifying the encoding processing, and reducing a processing amount. As for the encoded data, which is encoded by the moving image encoding apparatus, since the filter application information is stored in the buffer, and the encoding block division information is decoded and is associated with the filter application information while decoding the encoding block level syntax, a filter can be applied to regions set on the encoding side, thus decoding a moving image.

(Modification of this Embodiment)

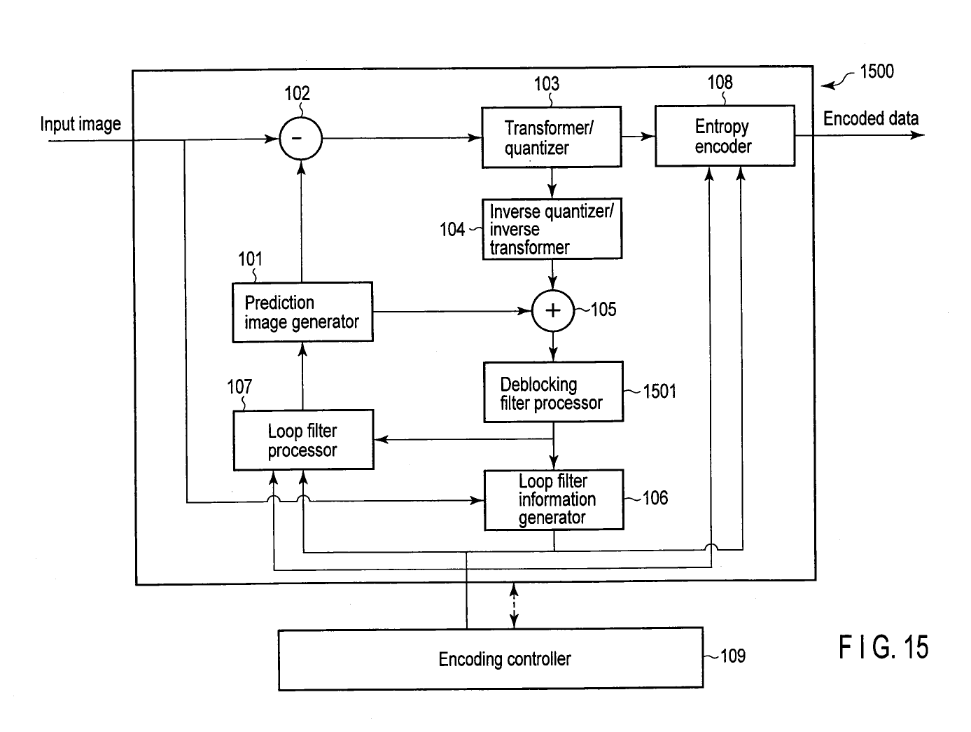

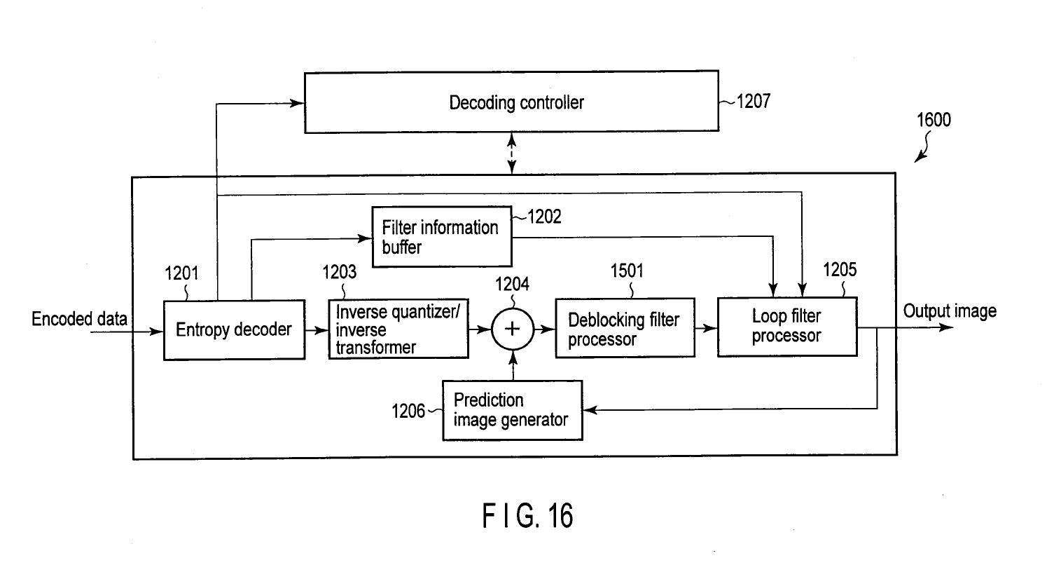

Note that the moving image encoding apparatus 100 and moving image decoding apparatus 1200 according to this embodiment execute filter processing for a local decoded image on the encoding side, and for a decoded image on the decoding side. However, the local decoded image and decoded image may use images after conventional deblocking filter processing is applied. An example of a moving image encoding apparatus and moving image decoding apparatus when executing deblocking filter processing will be described in detail below with reference to FIGS. 15 and 16.

FIG. 15 shows a moving image encoding apparatus 1500, which is different from the moving image encoding apparatus 100 shown in FIG. 1 in that it includes a deblocking filter processor 1501 in addition to the arrangement of the moving image encoding apparatus 100.

Likewise, FIG. 16 shows a moving image decoding apparatus 1600, which is different from the moving image decoding apparatus 1200 shown in FIG. 12 in that it includes a deblocking filter processor 1501 in addition to the arrangement of the moving image decoding apparatus 1200. The deblocking filter processor 1501 receives a decoded image from the adder 105 (1204), and applies deblocking filter processing to the decoded image, thereby generating a deblock-processed decoded image. By executing the loop filter processing using the deblock-processed decoded image, deterioration of a prediction image can be prevented.

Also, the moving image encoding apparatus 100 and moving image decoding apparatus 1200 according to this embodiment use the loop filter on both the encoding side and decoding side. However, the moving image encoding method and decoding method can be used even when the filter is applied to a decoded image, but it is not applied to an output image.

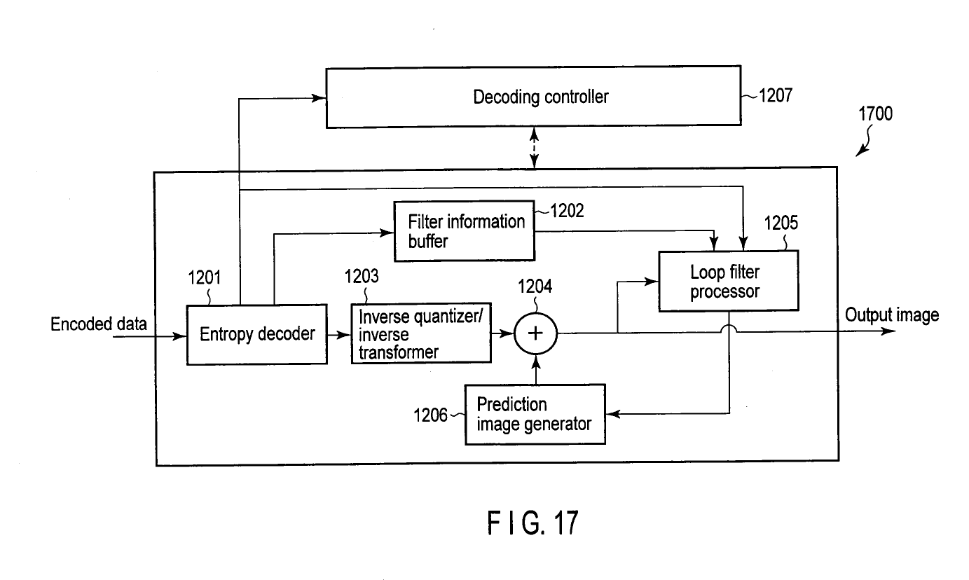

A moving image decoding apparatus in this case will be described below with reference to FIG. 17.

A moving image decoding apparatus 1700 is different from the moving image decoding apparatus 1200 shown in FIG. 12 in that it outputs a decoded image from the adder 1204 as an output image intact. Note that as for a moving image encoding apparatus, the moving image encoding apparatus shown in FIG. 1 can be used intact.

Furthermore, the moving image encoding apparatus 100 and moving image decoding apparatus 1200 according to this embodiment may be used as a post filter.

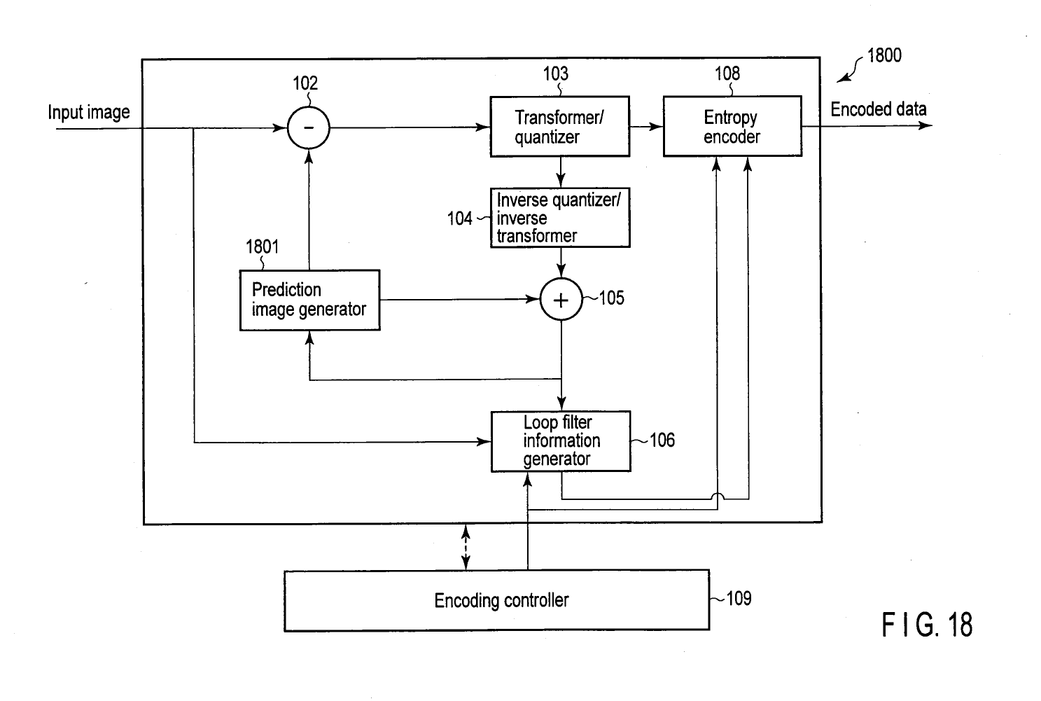

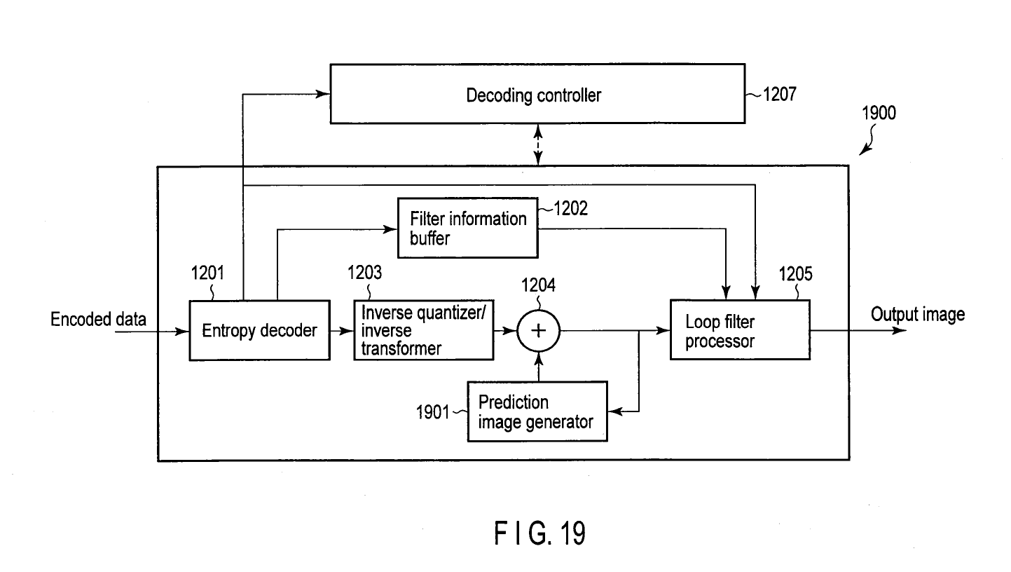

FIGS. 18 and 19 respectively show a moving image encoding apparatus and moving image decoding apparatus when they are used as a post filter.

A moving image encoding apparatus 1800 is implemented by removing the loop filter processor 107 in the moving image encoding apparatus 100 shown in FIG. 1, and inputting a decoded image to a prediction image generator 1801. Also, a moving image decoding apparatus 1900 is implemented by inputting a decoded image from the adder 1204 to a prediction image generator 1901.

Hence, according to this modification, the same effects as in this embodiment can be obtained.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving image decoding apparatus, comprising:
a decoder configured to decode an encoded data to obtain a filter information, an application information with a value appended to a head of the application information, a division information, and a quantized transform coefficient, the filter information indicating filter coefficient of a filter, the division information indicating how to divide an image to be decoded into blocks, the application information indicating whether or not to apply the filter to a block, the value indicating the number of blocks to which filter is applied; and
a processor configured to generate a reconstructed image by applying the filter to the block in a decoded image if the application information indicates the block to be applied the filter, the decoded image being obtained by adding a prediction error to a prediction image, the prediction error being generated by inverse-quantizing and inverse-transforming the quantized transform coefficient.

2. The apparatus according to claim 1, wherein the value is decoded by a decoding method decided using at least one of an image size, a maximum size of an block, a minimum size of the block, a maximum size of a filter application determination region indicating a pixel region as a unit required to determine whether or not a filter is applied to the block, and a minimum size of the filter application determination region.

3. The apparatus according to claim 1, wherein the decoder decodes the encoded data in which a first encoded data is appended before a second encoded data, the first encoded data including the encoded filter coefficient information and the encoded application information, the second encoded data including the encoded quantized transform coefficient and the encoded division information.

4. A moving image decoding apparatus, comprising:
a decoder configured to decode an encoded data to obtain a filter information, an application information with an end code appended to the end of the application information, a division information, and a quantized transform coefficient, the filter information indicating filter coefficient of a filter, the division information indicating how to divide an image to be decoded into blocks, the application information indicating whether or not to apply the filter to a block, the end code defining an end of the application information; and
a processor configured to generate a reconstructed image by applying the filter to the block in a decoded image if the application information indicates the block to be applied the filter, the decoded image being obtained by adding a prediction error to a prediction image, the prediction error being generated by inverse-quantizing and inverse-transforming the quantized transform coefficient.

5. A moving image decoding apparatus, comprising:
a decoder configured to decode an encoded data to obtain a filter information, an application information, a division information, and a quantized transform coefficient, the filter information indicating filter coefficient of a filter, the division information indicating how to divide an image to be decoded into blocks and appended to a head of the application information, the application information indicating whether or not to apply the filter to a block; and
a processor configured to generate a reconstructed image by applying the filter to the block in a decoded image if the application information indicates the block to be applied the filter, the decoded image being obtained by adding a prediction error to a prediction image, the prediction error being generated by inverse-quantizing and inverse-transforming the quantized transform coefficient.

6. A moving image decoding method, comprising:
decoding an encoded data to obtain a filter information, an application information with a value appended to a head of the application information, a division information, and a quantized transform coefficient, the filter information indicating filter coefficient of a filter, the division information indicating how to divide an image to be decoded into blocks, the application information indicating whether or not to apply the filter to a block, the value indicating the number of blocks to which filter is applied; and
generating a reconstructed image by applying the filter to the block in a decoded image if the application information indicates the block to be applied the filter, the decoded image being obtained by adding a prediction error to a prediction image, the prediction error being generated by inverse-quantizing and inverse-transforming the quantized transform coefficient.
